(19) United States
(12) Patent Application Publication
(10) Pub. No.: US 2007/0104926 A1
(43) Pub. Date: May 10, 2007

(54) Circuit device in particular frequency converter

(75) Inventors: Christian Goebl, Nuernberg (DE); Rainer Popp, Petersaurach (DE)

Correspondence Address: COHEN, PONTANI, LIEBERMAN & PAVANE, 551 FIFTH AVENUE, SUITE 1210, NEW YORK, NY, 10176, US

(73) Assignee: SEMIKRON Elektronik GmbH & Co. KG

(21) Appl. No.: 11/595,088

(22) Filed: Nov. 9, 2006

(30) Foreign Application Priority Data
Nov. 9, 2005 (DE) 10 2005 053 396.5

(51) Int. Cl. B32B 15/04; B32B 3/02

(52) U.S. Cl. 428/192; 428/457; 428/901

(57) ABSTRACT

A frequency converter is presented. The frequency converter includes a circuit module, which is interconnected to a circuit board and is connected to a heat sink. For attaining a frequency converter in a modular version with optimal cooling properties, the circuit module has a flexible, electrically insulating plastic film, which on one side has a circuit-structured logic metal layer and on the opposite side has a circuit-structured power metal layer that is contacted with a contact edge to a peripheral portion of the circuit board. The flexible circuit module protrudes at an angle away from the circuit board. Power semiconductor chips are contacted on the power metal layer. A substrate is secured to the heat sink and is embodied with a circuit structure for contacting the power semiconductor chips.

### BACKGROUND OF THE INVENTION

1. Field of the Invention

The invention relates to a circuit device, in particular a frequency converter, having a circuit module that is interconnected with a circuit board and is connected to a heat sink.

2. Description of the Related Art

Frequency converters in the prior art are constructed with transistors, thyristors (i.e., FET or MOSFET) (TOs), or with power semiconductor modules. The wiring plane and the cooling plane must always be taken into account. Standard modules are always constructed such that the wiring plane and the cooling plane are parallel to one another. Because of this embodiment with a cooling and a wiring plane that are parallel to one another, frequency converters in a so-called modular version are only conditionally attainable, because they are structurally too wide, which dictates a relatively wide switchgear cabinet and a necessarily high price. However, if such frequency converters are designed such that they are comparatively narrow modular versions, so that they fit the installation dimensions of contactor relays that are replaced by frequency converters, then the heat flow or in other words heat dissipation is problematic, since the heat must be conducted around a corner. This makes for less-effective cooling.

### SUMMARY OF THE INVENTION

In view of these given conditions, it is an object of the invention to create a circuit device, in particular a frequency converter, of the type defined at the outset that with a simple structure makes optimal cooling possible.

According to the invention, a circuit module has a flexible, electrically insulated plastic film, which on one side has a thin circuit-structured logic metal layer and on the opposite side has a circuit-structured power metal layer that is electrically contacted by a contact edge on a peripheral portion of the circuit board. The flexible circuit module protrudes at an angle from the circuit board. Power semiconductor chips are contacted at the circuit-structured power metal layer and a substrate is secured to the heat sink and is embodied with a circuit structure for contacting the power semiconductor chips.

The invention has the advantage that the flexible circuit module is bendable at points intended for that purpose. This means that the cooling plane and the wiring plane can form an arbitrary angle with one another. A very substantial advantage of the invention is that the circuit module, with its power semiconductor chips contacted on the circuit-structured power metal layer, and the circuit board can be joined to one another in the same plane by a known technology, such as soldering or welding. Accordingly, these two components can be pivoted relative to one another into any arbitrary angular position, or in other words a predetermined angular position. It is thus possible to make frequency converters of relatively small size, and this smaller dimensioning, which is optimally suited to modular solutions, is associated with effective cooling of the frequency converter.

According to the invention, the flexible circuit module has small frequency converters in comparison to the circuit board. The flexible circuit module can form an angle of 90° with the circuit board.

The substrate preferably has surface dimensions, which are adapted to the surface dimensions of the flexible circuit module.

The heat sink can have an angled metal sheet having a first and a second sheet-metal portion, and the substrate is fixed on the first sheet-metal portion, and the second sheet- metal portion has surface dimensions adapted to the circuit board. A cooling element can be fixed to the first sheet-metal portion. This cooling element may, for example, be embodied with cooling fins.

Further details, characteristics, and advantages will become apparent from the ensuing description of an exemplary embodiment, shown in the drawing, of the circuit device of the invention, in particular a frequency converter, in comparison with a frequency converter of the prior art—in a modular version.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic front elevation view, not to scale, illustrating an embodiment according to the invention of the circuit device, in particular a frequency converter in a modular version; and

FIG. 2 is a view similar to FIG. 1 illustrating a known frequency converter in a modular version.

### DETAILED DESCRIPTION OF THE PRESENTLY PREFERRED EMBODIMENTS

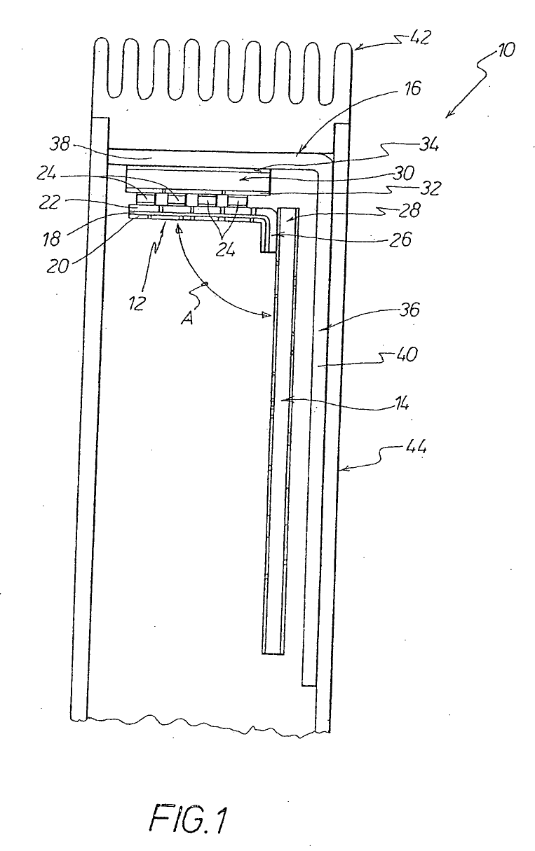

FIG. 1 schematically shows an embodiment of the circuit device of the invention, in particular a frequency converter 10, having a circuit module 12 that is interconnected with a circuit board 14 and is connected to a heat sink 16 in heat-dissipating fashion.

The circuit module 12 has a flexible, electrically insulated plastic film 18, which on one side has a thin circuit-structured logic metal layer 20 and on the opposite, second side has a circuit-structured power metal layer 22. Power semiconductor chips 24 are contacted on the power metal layer 22.

The circuit-structured power metal layer 22 is contacted by a contact edge 26 on a peripheral portion 28 of the circuit board 14. Power contacts and/or auxiliary contacts are connected here. This contacting is done by soldering or welding in an outset state of the circuit module 12, in which the circuit module 12 and the circuit board 14 are both positioned in the same plane. After the contacting, the circuit module 12 is bent away from the plane of the circuit board 14, so that the circuit module 12 forms an angle A with the circuit board 14. This angle A is 90°, for example.

A substrate 30 is secured to the heat sink 16 and is embodied on one side with a circuit structure 32 for contacting the power semiconductor chips 24. The opposite, second side of the substrate 30 has a metal layer 34, with which the substrate 30 is secured to the heat sink 16 in such a way that heat is well dissipated.

The heat sink 16 is formed by an angled metal sheet 36, which has a first sheet-metal portion 38 and a second sheet-metal portion 40. The substrate 30 is fixed to the first sheet-metal portion 38. The second sheet-metal portion 40 has surface dimensions, which are adapted to the surface dimensions of the circuit board 14. A cooling element 42, which is embodied with cooling fins, is secured in a heat-dissipating manner to the first sheet-metal portion 38.

Reference numeral 44 designates a housing of the frequency converter 10, the housing being indicated in only some portions. The frequency converter 10 of the invention has external dimensions such that it is optimally suitable for a so-called modular version.

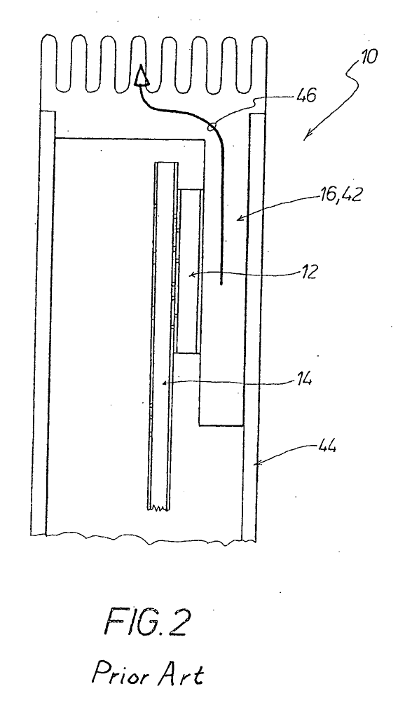

FIG. 2, in a view similar to FIG. 1, illustrates a known embodiment of a frequency converter 10 in a modular version; individual features that are the same are identified by the same reference numerals as in FIG. 1, so that in conjunction with FIG. 2 there is no need to describe these features again in detail. FIG. 2 is intended in particular to illustrate the inadequate, angled heat flow, or in other words heat dissipation, from the circuit module 12. This angled heat dissipation is indicated by the arrow 46.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A circuit device comprising:
a circuit board having a peripheral portion with a contact edge;
a heat sink;
a circuit module interconnected with the circuit board and connected in a heat-dissipating manner to the heat sink, wherein the circuit module includes a flexible, electrically insulated plastic film having a thin circuit-structured logic metal layer on one side and having a circuit-structured power metal layer on the opposite side, the circuit-structured power metal layer contacts the contact edge on the peripheral portion of the circuit board, and the circuit module protruding at an angle from the circuit board;
power semiconductor chips contacting the circuit-structured power metal layer of the circuit module; and
a substrate secured to the heat sink and embodied with a circuit structure contacting the power semiconductor chips.

2. The circuit device of claim 1, wherein the flexible circuit module has small frequency converters in comparison to the circuit board.

3. The circuit device of claim 1, wherein the circuit module forms an angle of 90° with the circuit board.

4. The circuit device of claim 1, wherein the substrate has surface dimensions which are adapted to the surface dimensions of the flexible circuit module.

5. The circuit device of claim 1, wherein the heat sink comprises an angled metal sheet having first and second sheet-metal portions, the substrate is fixed onto the first sheet-metal portion, and the second sheet-metal portion has surface dimensions adapted to the circuit board.

6. The circuit device of claim 5, further comprising a cooling element secured to the first sheet-metal portion.
